(19) United States
(12) Patent Application Publication
(10) Pub. No.: US 2012/0245980 A1
(43) Pub. Date: Sep. 27, 2012

(54) PRODUCTIVITY PREDICTION TECHNIQUE AND SYSTEM

(75) Inventors: Andrew John Cook, Bangalore (IN); Rajendra Tanniru Prasad, Bangalore (IN); Gayathri Pallail, Bangalore (IN); Uma Balasubramanian, Bangalore (IN); Lakshmi Abburu, Bangalore (IN); Sreevidya Prasad, Bangalore (IN)

(73) Assignee: ACCENTURE GLOBAL SERVICES LIMITED, Dublin (IE)

(21) Appl. No.: 13/426,674

(22) Filed: Mar. 22, 2012

(30) Foreign Application Priority Data
Mar. 22, 2011 (IN) 886/CHE/2011

(51) Int. Cl. G06Q 10/04

(52) U.S. Cl. 705/7.37

(57) ABSTRACT

Productivity prediction technique and system, in which user input defining workforce capability parameters is received and a prediction model is accessed. The prediction model quantifies an impact of workforce capability on productivity. The model was generated by applying statistical analysis on historical workforce data for projects and historical process metrics data for the projects. The prediction model is used to calculate a distribution of productivity for a given set of workforce capability parameters and the predicted productivity range for the workforce capability parameters is provided.

### CROSS-REFERENCE TO RELATED APPLICATION(S)

The present application claims the benefit of Indian Patent Application No. 886/CHE/2011, filed on Mar. 22, 2011, which is incorporated herein by reference in its entirety for all purposes.

### FIELD

This disclosure relates to a productivity prediction technique and system.

### BACKGROUND

People and process are inseparable parameters for running a business. However, organizations typically have independent frameworks and methods to establish workforce capability and process capability. Managing workforce and process capabilities separately might sometimes end up pulling the cart in two different directions and may not result in overall success of the business. Although organizations may establish effective and resource independent processes, it is the capability of the workforce that ultimately drives the success of projects. Hence, it is beneficial to integrate workforce capability and skills into the process capability as described throughout this disclosure.

### SUMMARY

In one aspect, a productivity prediction system includes at least one processor and at least one memory coupled to the at least one processor having stored thereon instructions which, when executed by the at least one processor, causes the at least one processor to perform operations. The operations include receiving user input defining workforce capability parameters and accessing a prediction model that quantifies an impact of workforce capability on productivity. The prediction model was generated by applying statistical analysis on historical workforce data for projects and historical process metrics data for the projects. The operations also include calculating, using the prediction model, a productivity prediction for the workforce capability parameters and providing the productivity prediction for the workforce capability parameters.

Implementations may include one or more of the following features. For example, the operations may include receiving user input defining workforce proficiency and accessing a prediction model that quantifies an impact of workforce proficiency on productivity. In this example, the prediction model was generated by applying statistical analysis on historical workforce proficiency data for projects and historical process metrics data for the projects. Further, in this example, the operations may include calculating, using the prediction model, a productivity prediction for the defined workforce proficiency and providing the productivity prediction for the defined workforce proficiency.

In some implementations, the operations may include receiving user defining a number of employees classified in each of multiple, predefined proficiency levels. In these implementations, the operations may include calculating, using the prediction model, a productivity prediction for the number of employees classified in each of multiple, predefined proficiency levels and providing the productivity prediction for the number of employees classified in each of multiple, predefined proficiency levels.

In addition, the operations may include calculating, using the prediction model, a predicted number of components per time period for the workforce capability parameters and providing the predicted number of components per time period for the workforce capability parameters. Also, the operations may include calculating, using the prediction model, low, average, and high productivity predictions for the workforce capability parameters and providing the low, average, and high productivity predictions for the workforce capability parameters. Further, the operations may include calculating, using the prediction model, a probability distribution of predicted productivity for the workforce capability parameters and displaying, on a graph, the probability distribution of predicted productivity for the workforce capability parameters.

In some examples, the operations may include receiving user input defining a confidence limit percentage to use for prediction and calculating, using the prediction model, a productivity prediction for the workforce capability parameters that meets the confidence limit percentage. The operations also may include determining whether a user has completed productivity prediction and, based on a determination that the user has completed productivity prediction, outputting productivity prediction data for planning purposes. The operations further may include, based on a determination that the user has not completed productivity prediction, continuing to receive user input defining workforce capability parameters and providing productivity predictions.

In some implementations, the operations may include receiving user input defining workforce capability parameters and automation related input and accessing a prediction model that quantifies an impact of workforce capability and automation on productivity. In these implementations, the prediction model was generated by applying statistical analysis on historical workforce data for projects, historical automation data for the projects, and historical process metrics data for the projects. Further, in these implementations, the operations may include calculating, using the prediction model, automation related prediction data and providing the automation related prediction data.

In some examples, the operations may include determining whether a user has completed prediction activities and, based on a determination that the user has completed prediction activities, outputting productivity and automation related prediction data for planning purposes. In these examples, the operations may include, based on a determination that the user has not completed prediction activities, continuing to receive user input defining workforce capability parameters and automation related input and providing productivity and automation related predictions.

In some implementations, the operations may include receiving user input defining workforce capability parameters and expected automation input. In these implementations, the operations may include calculating, using the prediction model, a first productivity prediction for the inputted workforce capability parameters and no automation and calculating, using the prediction model, a second productivity prediction for the inputted workforce capability parameters and the expected automation. Also, in these implementations, the operations may include providing the first productivity prediction for the inputted workforce capability parameters with no automation and the second productivity prediction for the inputted workforce capability parameters with the expected automation.

In some examples, the operations may include receiving user input defining an expected percentage of automation and calculating, using the prediction model, a first productivity prediction for the inputted workforce capability parameters and zero percentage of automation. In these examples, the operations may include calculating, using the prediction model, a second productivity prediction for the inputted workforce capability parameters and the expected percentage of automation and providing the first productivity prediction for the inputted workforce capability parameters with zero percentage of automation and the second productivity prediction for the inputted workforce capability parameters with the expected percentage of automation.

In addition, the operations may include calculating, using the prediction model, a first probability distribution of predicted productivity for the inputted workforce capability parameters and no automation. The first probability distribution of predicted productivity may include low, average, and high predicted productivity for the inputted workforce capability parameters and no automation. The operations also may include calculating, using the prediction model, a second probability distribution of predicted productivity for the inputted workforce capability parameters and the expected automation. The second probability distribution of predicted productivity may include an improved average predicted productivity for the inputted workforce capability parameters and the expected automation. The operations further may include displaying, on a graph included in an interface, the first probability distribution of predicted productivity, displaying, on the graph with the first probability distribution of predicted productivity, the second probability distribution of predicted productivity, displaying, in the interface, numeric output for the low, average, and high predicted productivity for the inputted workforce capability parameters and no automation, and displaying, in the interface, numeric output for the improved average predicted productivity for the inputted workforce capability parameters and the expected automation.

In some implementations, the operations may include receiving user input defining workforce capability parameters and target productivity input and calculating, using the prediction model, a prediction of automation needed to reach the target productivity based on the workforce capability parameters. In these implementations, the operations may include providing the prediction of the automation needed to reach the target productivity based on the workforce capability parameters.

In some examples, the operations may include receiving user input defining a target number of components per time period and calculating, using the prediction model, a prediction of automation needed to reach the target number of components per time period based on the workforce capability parameters. In these examples, the operations may include providing the prediction of automation needed to reach the target number of components per time period based on the workforce capability parameters.

The operations may include calculating, using the prediction model, a predicted percentage of automation needed to reach the target productivity based on the workforce capability parameters and providing the predicted percentage of automation needed to reach the target productivity based on the workforce capability parameters. The operations also may include receiving feedback from projects for which productivity predictions were calculated. The feedback may include actual productivity values for the projects. The operations further may include comparing the actual productivity values for the projects to the productivity predictions, tuning the prediction model based on the comparison and the actual productivity values for the projects, and using the tuned prediction model in future predictions.

In another aspect, a method includes receiving user input defining workforce capability parameters and accessing, from electronic storage, a prediction model that quantifies an impact of workforce capability on productivity. The prediction model was generated by applying statistical analysis on historical workforce data for projects and historical process metrics data for the projects. The method also includes calculating, by at least one processor and using the prediction model, a productivity prediction for the workforce capability parameters and providing the productivity prediction for the workforce capability parameters.

In yet another aspect, at least one computer-readable storage medium is encoded with executable instructions that, when executed by at least one processor, cause the at least one processor to perform operations. The operations include receiving user input defining workforce capability parameters and accessing a prediction model that quantifies an impact of workforce capability on productivity. The prediction model was generated by applying statistical analysis on historical workforce data for projects and historical process metrics data for the projects. The operations also include calculating, using the prediction model, a productivity prediction for the workforce capability parameters and providing the productivity prediction for the workforce capability parameters.

The details of one or more implementations are set forth in the accompanying drawings and the description, below. Other potential features and advantages of the disclosure will be apparent from the description and drawings, and from the claims.

### BRIEF DESCRIPTION OF THE DRAWINGS

FIGS. 1, 2, and 11 are diagrams of exemplary systems.

FIGS. 3, 5, 6, 8, and 10 are flowcharts of exemplary processes.

FIGS. 4, 7, and 9 are diagrams illustrating exemplary user interfaces.

### DETAILED DESCRIPTION

Software development or service is a predominantly collaborative, creative endeavor requiring the right mix of skills to deliver outcomes quickly and cost effectively. When designed properly, a process framework leverages the people capability to sustain and drive a high performing delivery process. The techniques described throughout this disclosure provide an approach which integrates people and process capabilities and enables a company to gain control of processes through managing and developing the work force.

In some implementations, the approach integrates both people and process practices by analyzing and selecting the people processes that are controllable and have a direct impact on the project delivery process. After selection, the selected people processes are integrated into the delivery methods. A common measurement program and framework may be used such that the people attributes (e.g., skill, knowledge, experience, etc.) are built into the same framework of delivery metrics. A governance framework may be used such that the people leads (e.g., human resources (HR)) and delivery leads (e.g., project managers) follow the common set of reporting processes and procedures. A prediction model is established which can help to control the project process by managing the attributes of selected people processes, and people attributes data is used for estimator calibration. The prediction model predicts the range/distribution of productivity based on the skill level and experience of the team. This quantifies the impact of workforce factors on the project delivery process performance.

For example, productivity is directly proportional to the skill level and experience (proficiency) of people working in a project. The prediction model quantifies the impact of proficiency on productivity (as a distribution) and thus can be used for project effort estimation or productivity improvement that can be committed to a client. The prediction model can be used in the project planning stage to estimate the optimum range of project effort given the proficiency index of a set of people or how many people are required at various proficiencies to meet the planned productivity. The prediction model also can be used during the project execution for releasing resources or containing cost or maintaining quality of deliverables. The prediction model further can be used during project execution to improve the project's productivity, thereby completing the work earlier than committed and improving bottom line (e.g., in fixed bid projects).

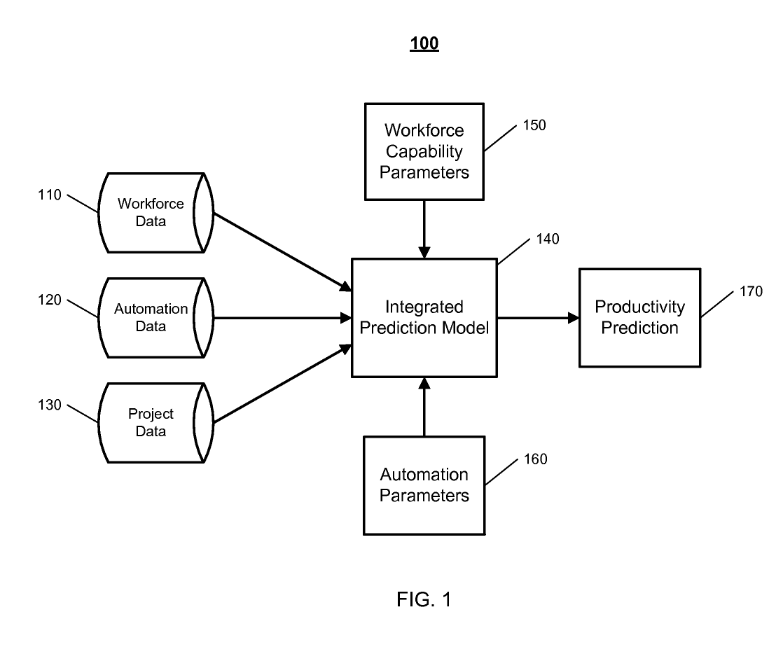

FIG. 1 illustrates an exemplary system 100 for generating productivity predictions. The system 100 includes a database 110 that stores historical workforce data, a database 120 that stores historical automation data, and a database 130 that stores historical project data. The system 100 also includes a computing device 140 that stores an integrated prediction model that is used to predict productivity based on input of workforce and automation parameters. Although three databases are shown for storing historical workforce data, historical automation data, and historical project data, more or fewer databases (or other data storage systems) may be used to store the historical workforce data, the historical automation data, and the historical project data.

The database 110 stores historical data about a company's workforce. The database 110 may be an employee database that stores employee proficiency (e.g., skill sets) data from different proficiency cycles. The database 110 may store any type of workforce data that may be used to predict productivity. For example, the workforce data may include data describing skills of employees, experience of employees, compensation of employees, age of employees, or any other workforce data that suggests proficiency of employees or correlates to productivity of the employees. In some implementations, the workforce data may include a proficiency level for each employee of a company. The proficiency level may be selected from among multiple (e.g., five), predefined proficiency levels that the company uses to classify proficiency of employees.

The database 120 stores historical data about a company's automation in projects. The database 120 may be a delivery process database that stores automation usage data for projects where employees of the company worked. The database 120 may store any type of automation data that quantifies automation of a project. For example, the automation data may include a percentage of automation that was achieved in each project or percentage of productivity improvement achieved through automation in each project engaged in by the company.

The database 130 stores historical data about projects engaged in by a company. The database 130 may be a delivery process database that stores process metrics data (e.g., productivity, etc.) for projects where employees of the company worked. The database 130 may store any type of project data that may be used to asses productivity in a project. For example, the project data may include data describing cost, schedule, quality, or any other process metrics that suggest a level of productivity for a given project. In some implementations, the project data may include a measure of a number of components produced per day at a given project or a number of lines of source code generated per day at a given project. Any productivity measure for a project may be used and predicted as long as the prediction model is tuned to predict the productivity measure based on inputs provided.

The database 110 and/or the database 130 stores identification data that enables identification of employees that worked on given projects for the company. From this identification data, workforce data, automation data, and project data may be compiled for all projects engaged in by a company and, for each project, a measure of workforce proficiency for the project may be determined, a measure of automation for the project may be determined, and a measure of productivity for the project may be determined.

An integrated prediction model may be generated using the measures and compiled data. For instance, statistical techniques may be performed on the measures and compiled data to generate a model that maps or correlates workforce proficiency and/or automation for a project to productivity for the project. The statistical techniques may include ANOVA (Analysis of Variance), regression analysis, Monte-Carlo simulation, and Scatterplot. Using historical workforce, automation, and project data, the prediction model integrates people and process capabilities and may provide a relatively accurate prediction of productivity range for future projects where the workforce proficiency and/or automation is known.

In some implementations, generation of the integrated prediction model may comply with a combination of two different bodies of knowledge (similar to certification standards). In these implementations, a body of knowledge for workforce capabilities may be combined with a body of knowledge for process capabilities. For instance, the integrated prediction model may comply to the People Capability Maturity Model (People CMM)® and the Capability Maturity Model Integration (CMMI)® to integrate people and process capabilities

After the integrated prediction model has been generated, the computing device 140 receives user input defining workforce capability parameters 150 for a project, receives user input defining automation parameters 160 for the project, and generates a productivity prediction 170 by applying the workforce capability parameters 150 and the automation parameters 160 to the integrated prediction model. The workforce capability parameters 150 may be any type of parameters that measure workforce capability or proficiency (e.g., number of employees in each of multiple, predefined proficiency levels) and the automation parameters 160 may be any type of parameters that define expected automation in a project (e.g., a percentage of automation). The productivity prediction 170 may be computed as any type of productivity measure (e.g., a number of components per day). The workforce capability parameters 150, the automation parameters 160, and the productivity prediction 170 may comply with the historical data used to generate the integrated prediction model, and other parameters/measures may be used by generating another prediction model that uses similar techniques, but is tuned to accept different inputs and provide different outputs.

Although the integrated prediction model has been described as inputting workforce capability parameters 150 for a project and automation parameters 160 for the project and outputting a productivity prediction 170, other options are also possible. For instance, the integrated prediction model may accept workforce capability parameters and target productivity as inputs and provide output indicating an amount of automation needed to reach the target productivity based on the workforce capability parameters. As another example, the integrated prediction model may accept target productivity as an input and provide output indicating workforce capability parameters that could meet the target productivity. Because multiple combinations of workforce capability parameters (and automation levels) could be used to achieve the target productivity, the integrated prediction model may provide output that lists the various possible combinations or output that lists a subset of the combinations based on criteria specified by a user (e.g., minimum and/or maximum threshold numbers of employees in each proficiency level and/or minimum and/or maximum percentages of automation).

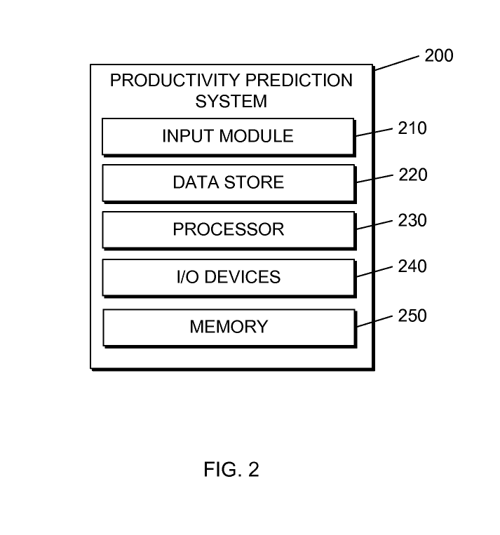

FIG. 2 illustrates an exemplary productivity prediction system 200 for generating productivity predictions. The system 200 includes an input module 210, a data store 220, one or more processors 230, one or more I/O (Input/Output) devices 240, and memory 250. The input module 220 may be used to input any type of information accepted by a prediction model leveraged by the system 200. For example, the input module 210 may be used to receive workforce capability parameters, automation parameters, and/or target productivity measures. In some implementations, data from the input module 210 is stored in the data store 220. The data included in the data store 220 may include, for example, the integrated prediction model, inputted workforce capability parameters and/or automation parameters, and corresponding productivity predictions.

In some examples, the data store 220 may be a relational database that logically organizes data into a series of database tables. Each database table in the data store 220 may arrange data in a series of columns (where each column represents an attribute of the data stored in the database) and rows (where each row represents attribute values). In some implementations, the data store 220 may be an object-oriented database that logically or physically organizes data into a series of objects. Each object may be associated with a series of attribute values. In some examples, the data store 220 may be a type of database management system that is not necessarily a relational or object-oriented database. For example, a series of XML (Extensible Mark-up Language) files or documents may be used, where each XML file or document includes attributes and attribute values. Data included in the data store 220 may be identified by a unique identifier such that data related to a particular process may be retrieved from the data store 220.

The processor 230 may be a processor suitable for the execution of a computer program such as a general or special purpose microprocessor, and any one or more processors of any kind of digital computer. In some implementations, the system 200 includes more than one processor 230. The processor 230 may receive instructions and data from the memory 250. The memory 250 may store instructions and data corresponding to any or all of the components of the system 200. The memory 250 may include read-only memory, random-access memory, or both.

The I/O devices 240 are configured to provide input to and output from the system 200. For example, the I/O devices 240 may include a mouse, a keyboard, a stylus, or any other device that allows the input of data. The I/O devices 240 may also include a display, a printer, or any other device that outputs data.

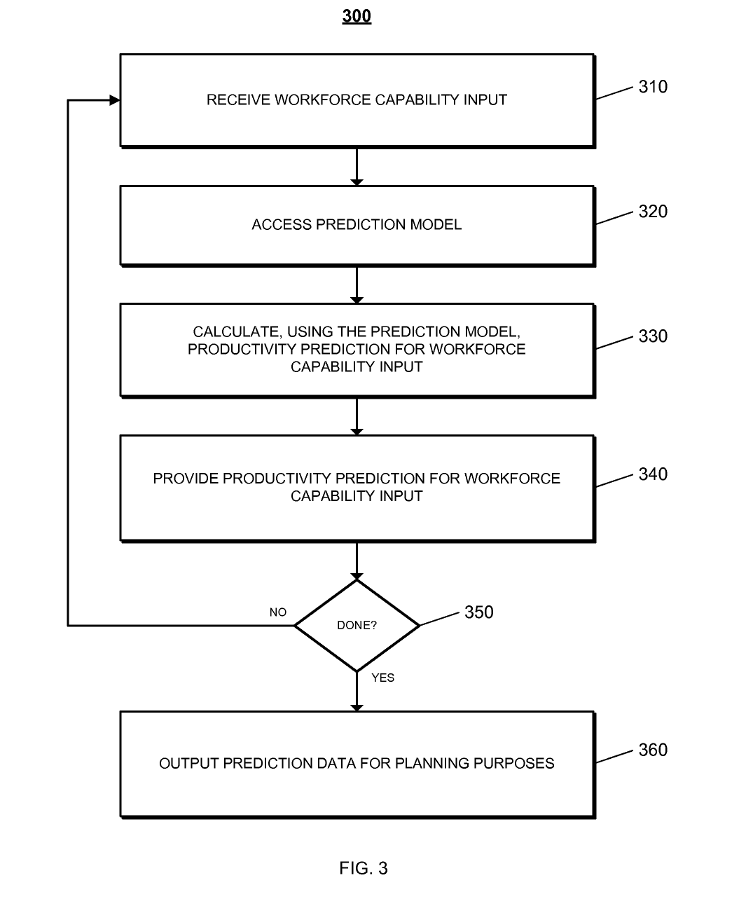

FIG. 3 illustrates a process 300 for providing productivity prediction data based on workforce capability input. The operations of the process 300 are described generally as being performed by the system 200. In some implementations, operations of the process 300 may be performed by one or more processors included in one or more electronic devices.

The system 200 receives workforce capability input (310). For instance, the system 200 receives user input indicating employee proficiency (e.g., skill sets) for a group of employees being considered for a project. The workforce capability input may include any type of workforce data that may be used to predict productivity, such as data describing skills of employees, experience of employees, compensation of employees, or any other workforce data that suggests proficiency of employees or correlates to productivity of the employees.

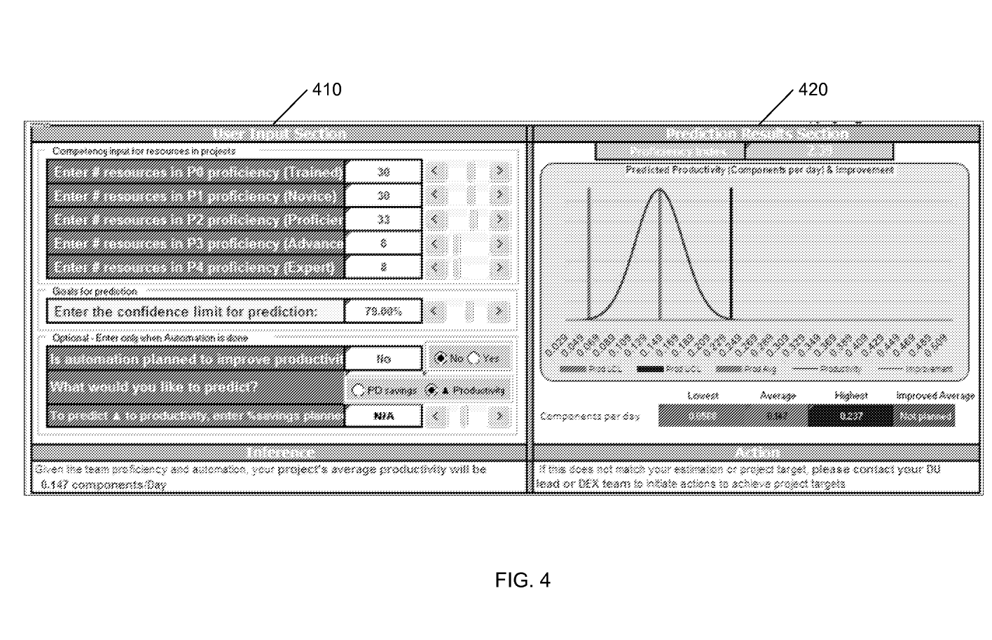

FIG. 4 illustrates an exemplary user interface 400 for productivity prediction. As shown in FIG. 4, the user interface 400 includes a user input section 410 that the system 200 may use to receive workforce capability input. The user input section 410 enables a user to enter competency input for resources in projects. In this example, five rows are displayed for a user to enter competency input for resources in projects, where each row corresponds to a predefined proficiency level that the company uses to classify employees. The five proficiency levels include a P0 proficiency level (Trained), a P1 proficiency level (Novice), a P2 proficiency level (Proficient), a P3 proficiency level (Advanced), and a P4 proficiency level (Expert).

The system 200 receives, through the user input section 410, user input defining a number of resources (e.g., number of employees) in each of the five proficiency levels. The system 200 receives the user input through user entry of numeric text in the text box for the corresponding proficiency level and/or through user manipulation of the slider control for the corresponding proficiency level. Although the user input section 410 receives user input defining a number of resources (e.g., number of employees) that are dedicated to a project full-time, other implementations may receive input defining resources (e.g., employees) that are committed to a project, but only on a part-time basis. In these implementations, the system 200 may receive user input defining a percentage commitment to the project for each proposed resource (e.g., employee) and assess contribution to productivity by each proposed resource (e.g., employee) in accordance with the percentage commitment.

Referring again to FIG. 3, the system 200 accesses a prediction model (320). For example, the system 200 retrieves, from electronic storage, an integrated prediction model. The integrated prediction model may quantify an impact of workforce capability on productivity and may have been generated by applying statistical analysis on historical workforce data for projects and historical process metrics data for the projects. The integrated prediction model described above with respect to FIG. 1 may be used. In the example shown in FIG. 4, the integrated prediction model may correlate the number of resources (e.g., employees) in each of the five proficiency levels to a measure of productivity. In this case, the integrated prediction model may have been generated by applying statistical analysis on historical data indicating a number of resources (e.g., employees) in each of the five proficiency levels for past projects and historical process metrics describing productivity measures for the past projects.

The system 200 calculates, using the prediction model, a productivity prediction for the workforce capability input (330). For instance, the system 200 applies the workforce capability input to the accessed prediction model and computes a productivity prediction for the workforce capability input. The productivity prediction may be any type of secondary measure, such as cost, schedule, quality that can be derived from productivity, or any other process metric that suggests a level of productivity for a project. In some implementations, the productivity prediction may include a measure of a number of components produced per day at a given project or a number of lines of source code generated per day at a given project. Any productivity measure for a project may be used and predicted as long as the integrated prediction model is tuned to predict the productivity measure based on inputs provided.

The system 200 provides the productivity prediction for the workforce capability input (340). For example, the system 200 displays the productivity prediction, sends the productivity prediction in an electronic communication (e.g., an electronic mail message), provides printed output of the productivity prediction, stores the productivity prediction, and/or provides the productivity prediction in any other manner that enables a user to perceive and/or later retrieve the productivity prediction.

The user interface 400 shown in FIG. 4 illustrates an example of calculating and providing productivity predictions. Specifically, the user interface 400 includes a prediction results section 420 that displays results of the calculated productivity prediction for the input provided in the user input section 410. The prediction results section 420 includes a proficiency index, a graph showing a probability distribution of predicted productivity with low, average, and high productivity predictions emphasized, and numeric representations of the low, average, and high productivity predictions.

The proficiency index is a numeric measure computed to represent the proficiency input provided in the user input section 410. For example, after receiving the number of resources (e.g., employees) in each proficiency level, the system 200 computes the proficiency index as a single numeric value that represents the number of resources (e.g., employees) data entered in the user input section 410. The proficiency index changes in accordance with changes to the number of resources (e.g., employees) entered in each proficiency level in the user input section 410. In some cases, different combinations of number of resources (e.g., employees) in each of the proficiency levels may result in the same proficiency index (e.g., four novice resources may have the same proficiency index as one expert resource).

The system 200 then uses the computed proficiency index to calculate a probability distribution of predicted productivity for the input provided in the user input section 410. In the example shown in FIG. 4, the probability distribution of predicted productivity is calculated in terms of a number of components produced per day. After computing the probability distribution, the system 200 generates a graph showing the probability distribution. The system 200 includes vertical lines emphasizing the low, average, and high predictions for the number of components produced per day given the number of resources (e.g., employees) entered in each proficiency level in the user input section 410. The system 200 also displays numeric values for the low, average, and high predictions for the number of components produced per day below the graph.

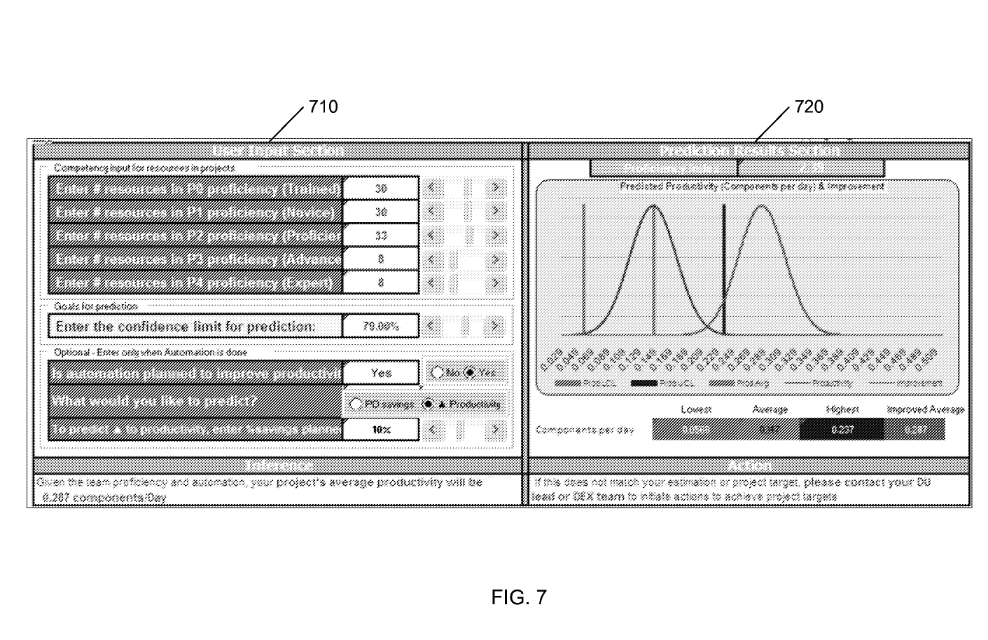

In the example shown in FIG. 4, the improved average field is shown as “Not Planned.” This is because the system 200 received user input indicating that no automation was planned for the project. The improved average field is described in more detail below with respect to FIG. 7.

Further, in the example shown in FIG. 4, the system 200 calculated the productivity prediction based on a confidence limit received in the user input section 410. In this example, a row is displayed for a user to enter the confidence limit desired for the prediction. The system 200 receives, through the user input section 410, user input defining a confidence limit percentage. The system 200 receives the user input through user entry of numeric text in the text box corresponding to confidence limit and/or through user manipulation of the slider control corresponding to confidence limit.

The system 200 uses the received user input defining the confidence limit to compute the productivity prediction. For instance, the system 200 applies the confidence limit to the integrated prediction model to calculate a productivity prediction distribution that meets the confidence limit.

Referring again to FIG. 3, the system 200 determines whether a user has completed productivity prediction (350). For instance, the system 200 determines whether the user has finished generating productivity predictions or wishes to continue inputting workforce capability input to view other predictions. The determination may be made based on user input provided by the user indicating whether or not the user has completed productivity prediction. Based on a determination that the user has not completed productivity prediction, the system 200 continues to receive user input defining workforce capability parameters and provide productivity predictions.

Based on a determination that the user has completed productivity prediction, the system 200 outputs productivity prediction data for planning purposes (360). For example, the system 200 may generate a report showing productivity predictions and may share the report with multiple users that are involved in a project. In this example, the system 200 may generate a report that shows all workforce inputs provided during productivity prediction and that shows corresponding productivity predictions or may generate a report showing a single workforce input selected by the user and the corresponding productivity prediction. The report (or other output) may be used to plan staffing for a project and/or to set requirements (e.g., budget/schedule) for the project. For existing projects, the report (or other output) may be used to modify staffing on the project to achieve a better result (e.g., reduce costs in meeting goals that are being overachieved with current staffing, increase staffing to ensure goals are actually met, etc.). Also, when the report (or other output) suggests that an existing project is not meeting a productivity prediction (e.g., too low or too high productivity), the users involved in the project may investigate the discrepancy, such as by determining whether resources (e.g., employees) in the project have been misclassified in accordance with the proficiency levels.

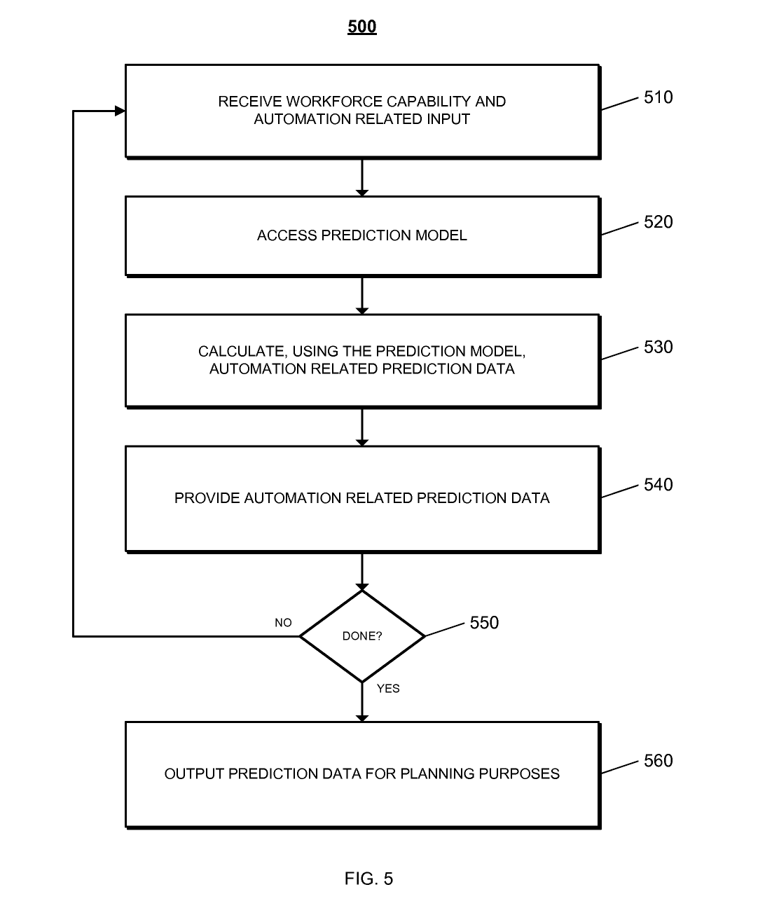

FIG. 5 illustrates a flowchart of an exemplary process 500 for providing prediction data based on workforce capability and automation related input. The operations of the process 500 are described generally as being performed by the system 200. In some implementations, operations of the process 500 may be performed by one or more processors included in one or more electronic devices.

The system 200 receives workforce capability and automation related input (510). For instance, the system 200 receives user input indicating employee proficiency (e.g., skill sets) for a group of employees being considered for a project. The workforce capability input may include any type of workforce data that may be used to predict productivity, such as data describing skills of employees, experience of employees, compensation of employees, age of employees, or any other workforce data that suggests proficiency of employees or correlates to productivity of the employees.

The system 200 also receives user input indicating automation related input. The automation related input may be any type of input related to automation. For instance, the automation related input may be automation data that quantifies expected automation of a project, such as a percentage of automation that is expected to be achieved (or is being achieved) in the project. The automation related input also may be input defining targets (e.g., productivity targets) for which the user would like to know how much automation is needed to reach the targets.

The system 200 accesses a prediction model (520). For example, the system 200 retrieves, from electronic storage, an integrated prediction model. The integrated prediction model may quantify an impact of workforce capability and automation on productivity and may have been generated by applying statistical analysis on historical workforce data for projects, historical automation data for the projects, and historical process metrics data for the projects. The integrated prediction model described above with respect to FIG. 1 may be used.

The system 200 calculates, using the prediction model, automation related prediction data (530). For instance, when expected automation input is received, the system 200 applies the workforce capability input and the expected automation input to the accessed prediction model and computes a productivity prediction for the workforce capability input at the expected level of automation. The productivity prediction may be any type of secondary measure, such as cost, schedule, quality that can be derived from productivity, or any other process metric that suggests a level of productivity for a project. In some implementations, the productivity prediction may include a measure of a number of components produced per day at a given project or a number of lines of source code generated per day at a given project. Any productivity measure for a project may be used and predicted as long as the integrated prediction model is tuned to predict the productivity measure based on inputs provided.

In other examples, the system 200 applies the workforce capability input and a target to the accessed prediction model and computes an automation level needed to reach the target. In these examples, the level of automation is an output and the automation related input is the target that a user desires to achieve.

The system 200 provides the automation related prediction data (540). For example, the system 200 displays the automation related prediction data, sends the automation related prediction data in an electronic communication (e.g., an electronic mail message), provides printed output of the automation related prediction data, stores the automation related prediction data, and/or provides the automation related prediction data in any other manner that enables a user to perceive and/or later retrieve the automation related prediction data.

The system 200 determines whether a user has completed prediction activities (550). For instance, the system 200 determines whether the user has finished prediction activities or wishes to continue inputting workforce capability and automation related input to view other predictions. The determination may be made based on user input provided by the user indicating whether or not the user has completed prediction activities. Based on a determination that the user has not completed prediction activities, the system 200 continues to receive user input defining workforce capability parameters and automation related input and provide predictions.

Based on a determination that the user has completed prediction activities, the system 200 outputs prediction data for planning purposes (560). For example, the system 200 may generate a report showing predictions and may share the report with multiple users that are involved in a project. In this example, the system 200 may generate a report that shows all workforce and automation related inputs provided during prediction and that shows corresponding predictions or may generate a report showing a single workforce and automation related input selected by the user and the corresponding prediction. The report (or other output) may be used to plan staffing/automation for a project and/or to set requirements (e.g., budget/schedule) for the project. For existing projects, the report (or other output) may be used to modify staffing/automation on the project to achieve a better result (e.g., reduce costs in meeting goals that are being overachieved with current automation, increase automation to ensure goals are actually met, etc.). Also, when the report (or other output) suggests that an existing project is not meeting a prediction (e.g., too low or too high productivity), the users involved in the project may investigate the discrepancy, such as by determining whether resources (e.g., employees) in the project have been misclassified in accordance with the proficiency levels and/or whether automation levels for the project have been incorrectly determined.

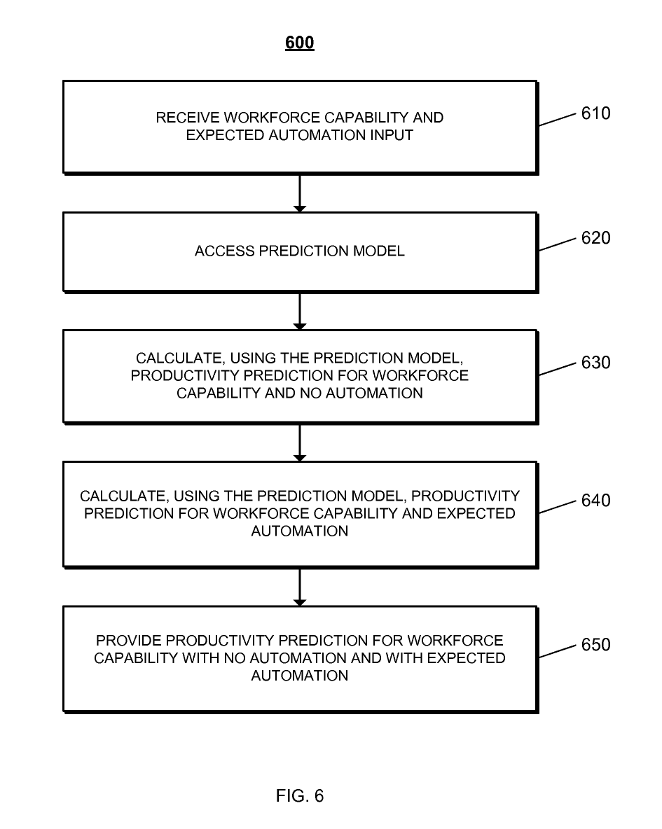

FIG. 6 illustrates a flowchart of an exemplary process 600 for providing productivity prediction data based on workforce capability and expected automation input. The process 600 is an example of the process 500 for providing prediction data based on workforce capability and automation related input. The operations of the process 600 are described generally as being performed by the system 200. In some implementations, operations of the process 600 may be performed by one or more processors included in one or more electronic devices.

The system 200 receives workforce capability and expected automation input (610). For instance, the system 200 receives user input indicating employee proficiency (e.g., skill sets) for a group of employees being considered for a project. The workforce capability input may include any type of workforce data that may be used to predict productivity, such as data describing skills of employees, experience of employees, compensation of employees, age of employees, or any other workforce data that suggests proficiency of employees or correlates to productivity of the employees.

The system 200 also receives user input indicating expected automation. The expected automation input may be any type of input that defines an expected level of automation. For instance, the automation related input may be automation data that quantifies expected automation of a project, such as a percentage of automation that is expected to be achieved (or is being achieved) in the project.

FIG. 7 illustrates an exemplary user interface 700 for productivity and automation related predictions. As shown in FIG. 7, the user interface 700 includes a user input section 710 that the system 200 may use to receive workforce capability and expected automation input. The portion of the user input section 710 for receiving workforce capability input is similar to the portion of the user input section 410 for receiving workforce capability input and operates in a similar manner.

In the example shown in FIG. 7, the user input section 710 includes a portion dedicated to receiving automation related input. In this example, a row is displayed for a user to select whether or not automation is planned. If input is provided indicating that automation is not planned, the system 200 calculates a productivity prediction based on the workforce capability parameters as described above with respect to FIG. 4.

If input is provided indicating that automation is planned, the system 200 receives, through the user input section 710, user input defining whether the user would like to predict productivity for an expected percentage of automation or whether the user would like to predict a percentage of automation needed to reach a target level of productivity. The system 200 receives the user input through user selection of an appropriate radio button.

In the example shown in FIG. 7, a selection has been made to predict productivity for an expected percentage of automation. In this example, the system 200 receives, through the user input section 710, user input defining the expected percentage of automation. The system 200 receives the expected percentage of automation through user entry of numeric text in the text box corresponding to enter percentage savings planned and/or through user manipulation of the slider control corresponding to enter percentage savings planned.

Referring again to FIG. 6, the system 200 accesses a prediction model (620). For example, the system 200 retrieves, from electronic storage, an integrated prediction model. The integrated prediction model may quantify an impact of workforce capability and automation on productivity and may have been generated by applying statistical analysis on historical workforce data for projects, historical automation data for the projects, and historical process metrics data for the projects. The integrated prediction model described above with respect to FIG. 1 may be used.

The system 200 calculates, using the prediction model, a productivity prediction for the inputted workforce capability and no automation (630). For instance, the system 200 applies the workforce capability input to the accessed prediction model and computes a productivity prediction for the workforce capability input without considering automation. This prediction is similar to the prediction described above with respect to reference numeral 330.

The system 200 calculates, using the prediction model, a productivity prediction for the inputted workforce capability and the expected automation (640). For instance, the system 200 applies the workforce capability input and the expected automation to the accessed prediction model and computes a productivity prediction for the workforce capability input at the expected automation. The productivity prediction may be any type of secondary measure, such as cost, schedule, quality that can be derived from productivity, or any other process metric that suggests a level of productivity for a project. In some implementations, the productivity prediction may include a measure of a number of components produced per day at a given project or a number of lines of source code generated per day at a given project. Any productivity measure for a project may be used and predicted as long as the integrated prediction model is tuned to predict the productivity measure based on inputs provided.

The system 200 provides the productivity prediction for the inputted workforce capability with no automation and with the expected automation (650). For example, the system 200 displays the productivity prediction, sends the productivity prediction in an electronic communication (e.g., an electronic mail message), provides printed output of the productivity prediction, stores the productivity prediction, and/or provides the productivity prediction in any other manner that enables a user to perceive and/or later retrieve the productivity prediction.

The user interface 700 shown in FIG. 7 illustrates an example of calculating and providing the productivity prediction for the inputted workforce capability with no automation and with the expected automation. Specifically, the user interface 700 includes a prediction results section 720 that displays results of the calculated productivity prediction for the input provided in the user input section 710. The prediction results section 720 includes a proficiency index, a graph showing prediction results, and numeric representations of prediction results. The graph includes a first probability distribution of predicted productivity for no automation with low, average, and high productivity predictions emphasized, and a second probability distribution of predicted productivity for the expected automation. The numeric representations show the low, average, and high productivity predictions for no automation and an improved average productivity prediction for the expected automation. The improved average shows the predicted average productivity with the expected automation.

The proficiency index is a numeric measure computed to represent the proficiency input provided in the user input section 710. The system 200 computes the proficiency index using techniques described above with respect to FIG. 4.

The system 200 then uses the computed proficiency index to calculate a first probability distribution of predicted productivity for the input provided in the user input section 710 with no automation. In the example shown in FIG. 7, the first probability distribution of predicted productivity is calculated in terms of a number of components produced per day. After computing the first probability distribution, the system 200 generates a graph showing the first probability distribution. The system 200 includes vertical lines emphasizing the low, average, and high predictions for the number of components produced per day given the number of resources (e.g., employees) entered in each proficiency level in the user input section 710. The system 200 also displays numeric values for the low, average, and high predictions for the number of components produced per day below the graph.

In addition, the system 200 calculates a second probability distribution of predicted productivity for the workforce and expected automation input provided in the user input section 710. In the example shown in FIG. 7, the second probability distribution of predicted productivity is calculated in terms of a number of components produced per day. The system 200 may compute the second probability distribution of predicted productivity by adjusting the first probability distribution of predicted productivity based on the expected automation. The adjustment may involve determining a constant amount of increase based on the expected automation and adding the constant amount of increase to the first probability distribution of predicted productivity. After computing the second probability distribution, the system 200 displays the second probability distribution on the graph with the first probability distribution. The graph allows a user to visually perceive how much productivity could be increased if the expected automation is realized. The system 200 also displays a numeric value for the improved average prediction for the number of components produced per day with the expected automation taken into account.

Further, in the example shown in FIG. 7, the system 200 calculated the productivity prediction based on a confidence limit received in the user input section 710. In this example, a row is displayed for a user to enter the confidence limit desired for the prediction. The system 200 receives, through the user input section 710, user input defining a confidence limit percentage. The system 200 receives the user input through user entry of numeric text in the text box corresponding to confidence limit and/or through user manipulation of the slider control corresponding to confidence limit.

The system 200 uses the received user input defining the confidence limit to compute the productivity prediction. For instance, the system 200 applies the confidence limit to the integrated prediction model to calculate a productivity prediction that meets the confidence limit with no automation and with the expected automation.

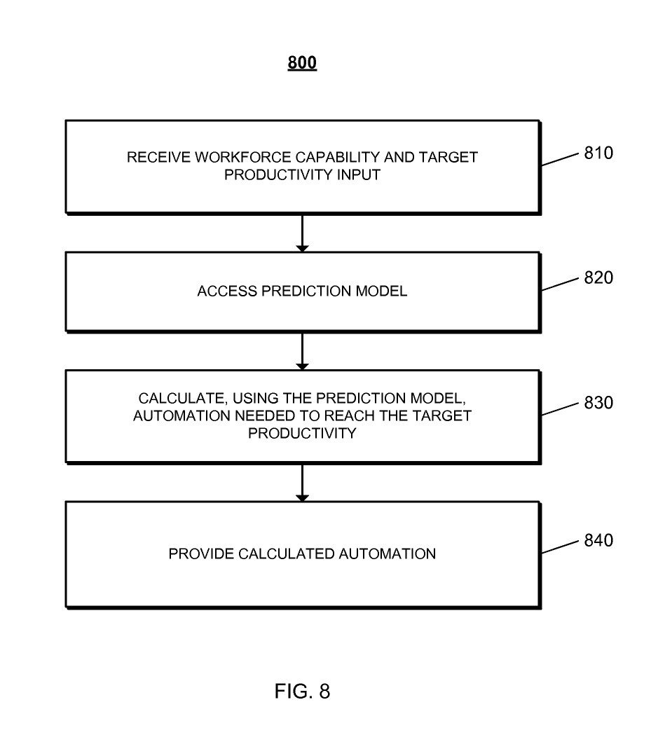

FIG. 8 illustrates a flowchart of an exemplary process 800 for providing predicted automation needed to reach a target productivity. The process 800 is an example of the process 500 for providing prediction data based on workforce capability and automation related input. The operations of the process 800 are described generally as being performed by the system 200. In some implementations, operations of the process 800 may be performed by one or more processors included in one or more electronic devices.

The system 200 receives workforce capability and target productivity input (810). For instance, the system 200 receives user input indicating employee proficiency (e.g., skill sets) for a group of employees being considered for a project. The workforce capability input may include any type of workforce data that may be used to predict productivity, such as data describing skills of employees, experience of employees, compensation of employees, age of employees, or any other workforce data that suggests proficiency of employees or correlates to productivity of the employees.

The system 200 also receives user input indicating target productivity. The target productivity input may be any type of input that defines target productivity for a project. For instance, the target productivity input may be input defining productivity targets for which the user would like to know how much automation is needed to reach the productivity targets.

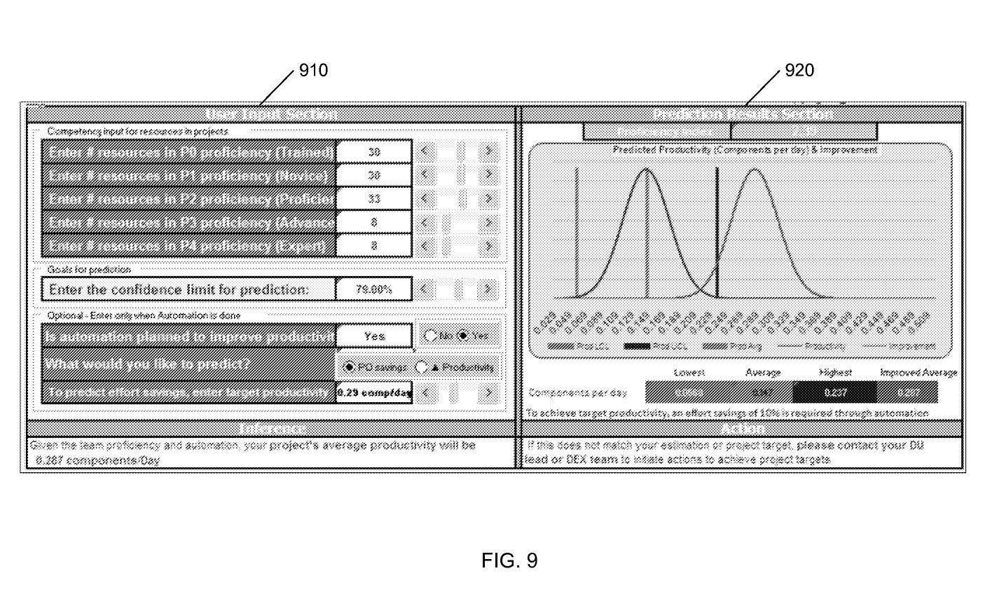

FIG. 9 illustrates an exemplary user interface 900 for productivity and automation related predictions. As shown in FIG. 9, the user interface 900 includes a user input section 910 that the system 200 may use to receive workforce capability and target productivity input. The portion of the user input section 910 for receiving workforce capability input is similar to the portion of the user input section 410 for receiving workforce capability input and operates in a similar manner.

In addition, the portion of the user input section 910 dedicated to receiving automation related input is similar to the portion of the user input section 710 for receiving automation related input and operates in a similar manner. In this example, however, a selection has been made to predict a percentage of automation needed to reach a target level of productivity. Based on the selection, the system 200 receives, through the user input section 910, user input defining the target productivity in terms of a number of components per day. The system 200 receives the target productivity through user entry of numeric text in the text box corresponding to enter target productivity and/or through user manipulation of the slider control corresponding to enter target productivity.

Referring again to FIG. 8, the system 200 accesses a prediction model (820). For example, the system 200 retrieves, from electronic storage, an integrated prediction model. The integrated prediction model may quantify an impact of workforce capability and automation on productivity and may have been generated by applying statistical analysis on historical workforce data for projects, historical automation data for the projects, and historical process metrics data for the projects. The integrated prediction model described above with respect to FIG. 1 may be used.

The system 200 calculates, using the prediction model, automation needed to reach the target productivity (830). For instance, the system 200 applies the workforce capability input and the target productivity to the accessed prediction model and computes a level of automation needed to reach the target productivity. The level of automation may be computed as a percentage of automation needed to reach the target productivity.

The system 200 provides the calculated automation (840). For example, the system 200 displays the calculated automation, sends the calculated automation in an electronic communication (e.g., an electronic mail message), provides printed output of the calculated automation, stores the calculated automation, and/or provides the calculated automation in any other manner that enables a user to perceive and/or later retrieve the calculated automation.

The user interface 900 shown in FIG. 9 illustrates an example of calculating and providing the calculated automation for the inputted workforce capability and target productivity. Specifically, the user interface 900 includes a prediction results section 920 that displays results of the calculated productivity prediction for the input provided in the user input section 910. The prediction results section 920 is similar to the prediction results section 720 described above with respect to FIG. 7, expect that the improved average value and the plot of the probability distribution that accounts for automation are set based on the target productivity entered in the user input section 910. In addition, the prediction results section 920 displays a message indicating the percentage of automation needed to reach the target productivity. In this case, the prediction results section 920 indicates that ten percent automation is needed to improve the predicted productivity for the inputted workforce capability parameters to the target productivity.

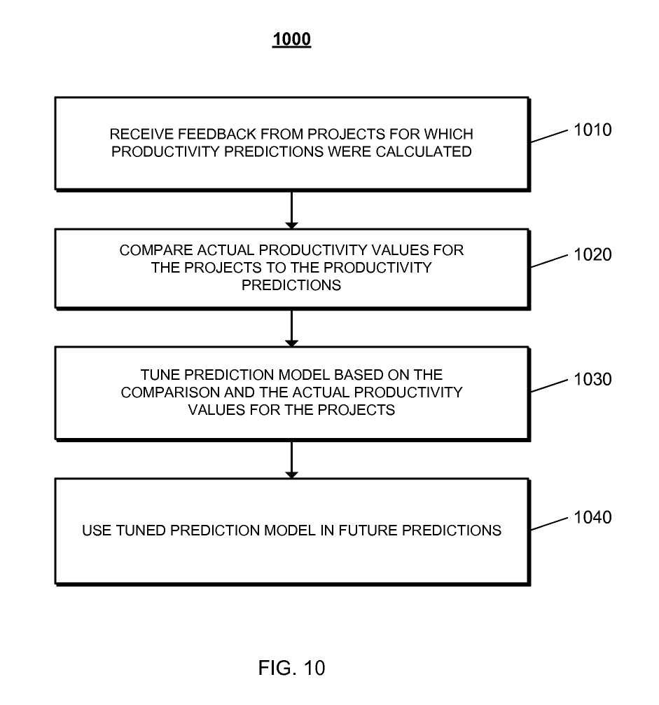

FIG. 10 illustrates a flowchart of an exemplary process 1000 for tuning a prediction model. The operations of the process 1000 are described generally as being performed by the system 200. In some implementations, operations of the process 1000 may be performed by one or more processors included in one or more electronic devices.

The system 200 receives feedback from projects for which productivity predictions were calculated (1010). For instance, the system 200 receives user input describing the actual productivity results being achieved by the projects for which productivity predictions were calculated. The system 200 may receive the actual productivity results using any type of one or more productivity measures, such as number of components per period of time.

The feedback also may indicate whether the workforce capability (e.g., number of employees in each proficiency level) and/or the automation (e.g., automation percentage) of the project match the workforce capability input (e.g., inputted number of employees in each proficiency level) and/or the expected automation (e.g., the inputted expected automation percentage) used in calculating the predictions. When the actual values do not meet the values used for prediction, the feedback data may be ignored or new predictions may be calculated for purposes of tuning the prediction model using the techniques described below.

The system 200 compares actual productivity values for the projects to the productivity predictions (1020). For instance, the system 200 compares the feedback data received to stored data indicating predictions calculated for the projects. Based on the comparison, the system 200 determines how close the predictions were to the actual productivity values (e.g., whether the predictions match or are within a threshold of the actual productivity values).

The system 200 tunes the prediction model based on the comparison and the actual productivity values for the projects (1030). When all of the predictions are within a threshold of the actual productivity values being achieved, the system 200 may determine that the prediction model is operating in a satisfactory manner and further tuning is not needed.

When one or more of the predictions are not within a threshold of the actual productivity values being achieved, the system 200 may determine that the prediction model would benefit from tuning. For example, the system 200 may automatically tune the prediction model by applying statistical analysis on the feedback received. In this example, the system 200 may adjust the prediction model to better fit the new data received in the feedback. In tuning the prediction model, the system 200 may consider data points where the predications were incorrect alone or in combination with data points where the predications were correct. Also, the system 200 may consider the historical data used to generate the prediction model in the first instance in combination with the new data received in the feedback. The system 200 may tune the prediction model based on user input provided by an operator reviewing the feedback and/or statistical analysis of the feedback.

The system 200 uses the tuned prediction model in future predictions (1040). For example, the system 200 uses the tuned prediction model to perform one or more of the processes 300, 500, 600, and 800 described above with respect to FIGS. 3, 5, 6, and 8, respectively.

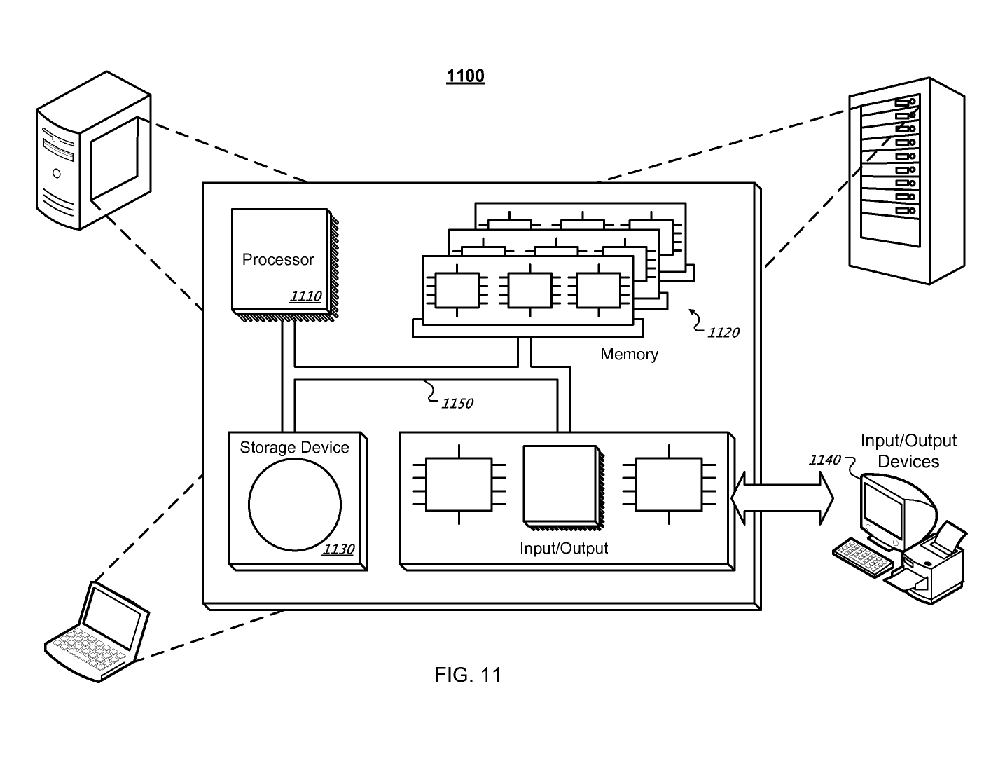

FIG. 11 is a schematic diagram of an example of a generic computer system 1100. The system 1100 can be used for the operations described in association with the processes 300, 500, 600, 800, and 1000, according to some implementations. The system 1100 may be included in the systems 100 and 200.

The system 1100 includes a processor 1110, a memory 1120, a storage device 1130, and an input/output device 1140. Each of the components 1110, 1120, 1130, and 1140 are interconnected using a system bus 1150. The processor 1110 is capable of processing instructions for execution within the system 1100. In one implementation, the processor 1110 is a single-threaded processor. In another implementation, the processor 1110 is a multi-threaded processor. The processor 1110 is capable of processing instructions stored in the memory 1120 or on the storage device 1130 to display graphical information for a user interface on the input/output device 1140.

The memory 1120 stores information within the system 1100. In one implementation, the memory 1120 is a computer-readable medium. In one implementation, the memory 1120 is a volatile memory unit. In another implementation, the memory 1120 is a non-volatile memory unit.

The storage device 1130 is capable of providing mass storage for the system 1100. In one implementation, the storage device 1130 is a computer-readable medium. In various different implementations, the storage device 1130 may be a floppy disk device, a hard disk device, an optical disk device, or a tape device.

The input/output device 1140 provides input/output operations for the system 1100. In one implementation, the input/output device 1140 includes a keyboard and/or pointing device. In another implementation, the input/output device 1140 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of the disclosure. Accordingly, other implementations are within the scope of the following claims.

What is claimed is:

1. A productivity prediction system comprising:
at least one processor; and
at least one memory coupled to the at least one processor having stored thereon instructions which, when executed by the at least one processor, causes the at least one processor to perform operations comprising:
receiving user input defining workforce capability parameters;
accessing a prediction model that quantifies an impact of workforce capability on productivity and that was generated by applying statistical analysis on historical workforce data for projects and historical process metrics data for the projects;
calculating, using the prediction model, a productivity prediction for the workforce capability parameters; and
providing the productivity prediction for the workforce capability parameters.

2. The productivity prediction system of claim 1:
wherein receiving user input defining workforce capability parameters comprises receiving user input defining workforce proficiency;
wherein accessing the prediction model comprises accessing a prediction model that quantifies an impact of workforce proficiency on productivity and that was generated by applying statistical analysis on historical workforce proficiency data for projects and historical process metrics data for the projects;
wherein calculating, using the prediction model, the productivity prediction for the workforce capability parameters comprises calculating, using the prediction model, a productivity prediction for the defined workforce proficiency; and
wherein providing the productivity prediction for the workforce capability parameters comprises providing the productivity prediction for the defined workforce proficiency.

3. The productivity prediction system of claim 2:
wherein receiving user input defining workforce proficiency comprises receiving user defining a number of employees classified in each of multiple, predefined proficiency levels;
wherein calculating, using the prediction model, a productivity prediction for the defined workforce proficiency comprises calculating, using the prediction model, a productivity prediction for the number of employees classified in each of multiple, predefined proficiency levels; and
wherein providing the productivity prediction for the defined workforce proficiency comprises providing the productivity prediction for the number of employees classified in each of multiple, predefined proficiency levels.

4. The productivity prediction system of claim 1:
wherein calculating, using the prediction model, the productivity prediction for the workforce capability parameters comprises calculating, using the prediction model, a predicted number of components per time period for the workforce capability parameters; and
wherein providing the productivity prediction for the workforce capability parameters comprises providing the predicted number of components per time period for the workforce capability parameters.

5. The productivity prediction system of claim 1:
wherein calculating, using the prediction model, the productivity prediction for the workforce capability parameters comprises calculating, using the prediction model, low, average, and high productivity predictions for the workforce capability parameters; and
wherein providing the productivity prediction for the workforce capability parameters comprises providing the low, average, and high productivity predictions for the workforce capability parameters.

6. The productivity prediction system of claim 1:
wherein calculating, using the prediction model, the productivity prediction for the workforce capability parameters comprises calculating, using the prediction model, a probability distribution of predicted productivity for the workforce capability parameters; and
wherein providing the productivity prediction for the workforce capability parameters comprises displaying, on a graph, the probability distribution of predicted productivity for the workforce capability parameters.

7. The productivity prediction system of claim 1:
wherein the operations further comprise receiving user input defining a confidence limit percentage to use for prediction; and
wherein calculating, using the prediction model, the productivity prediction for the workforce capability parameters comprises calculating, using the prediction model, a productivity prediction for the workforce capability parameters that meets the confidence limit percentage.

8. The productivity prediction system of claim 1, wherein the operations further comprise:
determining whether a user has completed productivity prediction;
based on a determination that the user has completed productivity prediction, outputting productivity prediction data for planning purposes; and
based on a determination that the user has not completed productivity prediction, continuing to receive user input defining workforce capability parameters and providing productivity predictions.

9. The productivity prediction system of claim 1:
wherein receiving user input defining workforce capability parameters comprises receiving user input defining workforce capability parameters and automation related input;
wherein accessing the prediction model comprises accessing a prediction model that quantifies an impact of workforce capability and automation on productivity and that was generated by applying statistical analysis on historical workforce data for projects, historical automation data for the projects, and historical process metrics data for the projects;
wherein calculating, using the prediction model, a productivity prediction for the workforce capability parameters comprises calculating, using the prediction model, automation related prediction data; and
wherein providing the productivity prediction for the workforce capability parameters comprises providing the automation related prediction data.

10. The productivity prediction system of claim 9, wherein the operations further comprise:
determining whether a user has completed prediction activities;
based on a determination that the user has completed prediction activities, outputting productivity and automation related prediction data for planning purposes; and
based on a determination that the user has not completed prediction activities, continuing to receive user input defining workforce capability parameters and automation related input and providing productivity and automation related predictions.

11. The productivity prediction system of claim 9:
wherein receiving user input defining workforce capability parameters and automation related input comprises receiving user input defining workforce capability parameters and expected automation input;
wherein calculating, using the prediction model, automation related prediction data comprises:
calculating, using the prediction model, a first productivity prediction for the inputted workforce capability parameters and no automation, and
calculating, using the prediction model, a second productivity prediction for the inputted workforce capability parameters and the expected automation; and
wherein providing the automation related prediction data comprises providing the first productivity prediction for the inputted workforce capability parameters with no automation and the second productivity prediction for the inputted workforce capability parameters with the expected automation.

12. The productivity prediction system of claim 11:
wherein receiving user input defining expected automation input comprises receiving user input defining an expected percentage of automation;
wherein calculating, using the prediction model, the first productivity prediction for the inputted workforce capability parameters and no automation comprises calculating, using the prediction model, a first productivity prediction for the inputted workforce capability parameters and zero percentage of automation;
wherein calculating, using the prediction model, the second productivity prediction for the inputted workforce capability parameters and the expected automation comprises calculating, using the prediction model, a second productivity prediction for the inputted workforce capability parameters and the expected percentage of automation; and
wherein providing the first productivity prediction for the inputted workforce capability parameters with no automation and the second productivity prediction for the inputted workforce capability parameters with the expected automation comprises providing the first productivity prediction for the inputted workforce capability parameters with zero percentage of automation and the second productivity prediction for the inputted workforce capability parameters with the expected percentage of automation.

13. The productivity prediction system of claim 11:
wherein calculating, using the prediction model, the first productivity prediction for the inputted workforce capability parameters and no automation comprises calculating, using the prediction model, a first probability distribution of predicted productivity for the inputted workforce capability parameters and no automation, the first probability distribution of predicted productivity including low, average, and high predicted productivity for the inputted workforce capability parameters and no automation;
wherein calculating, using the prediction model, the second productivity prediction for the inputted workforce capability parameters and the expected automation comprises calculating, using the prediction model, a second probability distribution of predicted productivity for the inputted workforce capability parameters and the expected automation, the second probability distribution of predicted productivity including an improved average predicted productivity for the inputted workforce capability parameters and the expected automation; and
wherein providing the first productivity prediction for the inputted workforce capability parameters with no automation and the second productivity prediction for the inputted workforce capability parameters with the expected automation comprises:
displaying, on a graph included in an interface, the first probability distribution of predicted productivity;
displaying, on the graph with the first probability distribution of predicted productivity, the second probability distribution of predicted productivity;
displaying, in the interface, numeric output for the low, average, and high predicted productivity for the inputted workforce capability parameters and no automation; and
displaying, in the interface, numeric output for the improved average predicted productivity for the inputted workforce capability parameters and the expected automation.

14. The productivity prediction system of claim 9:
wherein receiving user input defining workforce capability parameters and automation related input comprises receiving user input defining workforce capability parameters and target productivity input;
wherein calculating, using the prediction model, automation related prediction data comprises calculating, using the prediction model, a prediction of automation needed to reach the target productivity based on the workforce capability parameters; and
wherein providing the automation related prediction data comprises providing the prediction of the automation needed to reach the target productivity based on the workforce capability parameters.

15. The productivity prediction system of claim 14:
wherein receiving user input defining target productivity input comprises receiving user input defining a target number of components per time period;
wherein calculating, using the prediction model, a prediction of automation needed to reach the target productivity based on the workforce capability parameters comprises calculating, using the prediction model, a prediction of automation needed to reach the target number of components per time period based on the workforce capability parameters; and
wherein providing the prediction of the automation needed to reach the target productivity based on the workforce capability parameters comprises providing the prediction of automation needed to reach the target number of components per time period based on the workforce capability parameters.

16. The productivity prediction system of claim 14:
wherein calculating, using the prediction model, a prediction of automation needed to reach the target productivity based on the workforce capability parameters comprises calculating, using the prediction model, a predicted percentage of automation needed to reach the target productivity based on the workforce capability parameters; and
wherein providing the prediction of the automation needed to reach the target productivity based on the workforce capability parameters comprises providing the predicted percentage of automation needed to reach the target productivity based on the workforce capability parameters.

17. The productivity prediction system of claim 1, wherein the operations further comprise:
receiving feedback from projects for which productivity predictions were calculated, the feedback including actual productivity values for the projects;
comparing the actual productivity values for the projects to the productivity predictions; and
tuning the prediction model based on the comparison and the actual productivity values for the projects.

18. The productivity prediction system of claim 1, wherein the operations further comprise using the tuned prediction model in future predictions.

19. A method comprising:
receiving user input defining workforce capability parameters;
accessing, from electronic storage, a prediction model that quantifies an impact of workforce capability on productivity and that was generated by applying statistical analysis on historical workforce data for projects and historical process metrics data for the projects;
calculating, by at least one processor and using the prediction model, a productivity prediction for the workforce capability parameters; and
providing the productivity prediction for the workforce capability parameters.

20. At least one computer-readable storage medium encoded with executable instructions that, when executed by at least one processor, cause the at least one processor to perform operations comprising:
receiving user input defining workforce capability parameters;
accessing a prediction model that quantifies an impact of workforce capability on productivity and that was generated by applying statistical analysis on historical workforce data for projects and historical process metrics data for the projects;
calculating, using the prediction model, a productivity prediction for the workforce capability parameters; and
providing the productivity prediction for the workforce capability parameters.
